(19) United States
(12) Patent Application Publication
(10) Pub. No.: US 2026/0266676 A1
(43) Pub. Date: Sep. 10, 2026

(54) UTILIZING A FOUR-THERMISTOR CIRCUIT TO IMPROVE THE ACCURACY OF AN UNAMPLIFIED MEMS PRESSURE SENSOR

(71) Applicant: SENSATA TECHNOLOGIES, INC., ATTLEBORO, MA (US)

(72) Inventors: KEVIN C. DAO, MOORPARK, CA (US); IMAN SHAHOSSEINI, WOODLAND HILLS, CA (US); GABRIEL GONZALEZ, FILLMORE, CA (US)

(21) Appl. No.: 18/876,361

(22) PCT Filed: May 26, 2023
(86) PCT No.: PCT/US2023/023730

§ 371 Date: Dec. 18, 2024

Related U.S. Application Data
(60) Provisional application No. 63/357,114, filed on Jun. 30, 2022.

(51) Int. Cl. G01L 9/00; G01K 1/02; G01K 7/22

(52) U.S. Cl. CPC G01L 9/0052; G01K 1/026; G01K 7/22

(57) ABSTRACT

Utilizing a four-thermistor circuit to improve the accuracy of a pressure sensing device is disclosed. In a particular embodiment, a pressure sensor includes a pressure sensing element; two or more first thermistors electrically coupled to the pressure sensing element, the two or more first thermistors providing compensation for deviation of the pressure sensing element in a lower thermal range; and two or more second thermistors electrically coupled to the pressure sensing element, the two or more second thermistors providing compensation for deviation of the pressure sensing element in a lower thermal range.

### BACKGROUND

In the aerospace industry, it is reported that more than 80% of the Piezoresistive MEMS Pressure Sensors are configured with passive electronics (also known as “unamplified”) for their higher reliability and operating temperature range. Contrary to “amplified” sensors, where an ASIC (Signal Conditioner) is used to calibrate the units and adjust the sensor output, unamplified sensors utilize a series of resistors and thermistors (for which the resistance changes with temperature) for calibration. While for the amplified sensors the ASIC can be programmed to thermally compensate the deviation of the piezoresistive micro-electromechanical system (MEMS) die from the nominal output, for passive circuits the thermistors play the role of thermal compensation.

### SUMMARY

Embodiments in accordance with the present disclosure provide a calibration mechanism for unamplified MEMS pressure sensors using at least four thermistors in which at least two of these thermistors are provided to compensate for the thermal deviation of the MEMS die in an upper temperature range (e.g., at room and hot temperatures), and at least two thermistors are provided to compensate for the thermal deviation in a lower temperature range (e.g., cold temperatures). Passive circuits using one or two thermistors can thermally compensate MEMS die deviation at room and hot temperatures. However, at cold temperature (below −20° C.) the sensor output error increases. In some conditions, the sensor error may be close to 4% of full scale at −55° C. The four thermistor configuration in accordance with the present disclosure provides higher reading accuracy when compared to the one or two thermistor configuration, with significant accuracy improvement at cold temperatures below −20° C.

An embodiment is directed to a pressure sensor utilizing a four-thermistor circuit to improve accuracy. The pressure sensor includes a pressure sensing element. The pressure sensor further includes two or more first thermistors electrically coupled to the pressure sensing element, the two or more first thermistors providing compensation for deviation of the pressure sensing element in a lower thermal range. The pressure sensor further includes two or more second thermistors electrically coupled to the pressure sensing element, the two or more second thermistors providing compensation for deviation of the pressure sensing element in an upper thermal range. In some examples, the pressure sensor is an unamplified pressure sensor. In some examples, the pressure sensor is piezoresistive pressure sensor.

In some examples, the two or more first thermistors have a resistance of 10 Ω at room temperature a beta sensitivity coefficient of 3470. In some examples, the two or more second thermistors have a resistance of 500 Ω at room temperature and a beta sensitivity coefficient of 2941.

In some examples, the pressure sensing element is a micro-electromechanical system (MEMS) die. The MEMS die may be mounted on a printed circuit board (PCB) assembly and the two or more first thermistors and the two or more second thermistors are disposed on the PCB assembly. In some examples, the wherein the PCB assembly includes a first lower thermal range compensation stage including one of the first thermistors and one or more linearizing resistors, a second lower thermal range compensation stage including one of the first thermistors and one or more linearizing resistors, a first upper thermal range compensation stage including one of the second thermistors and one or more linearizing resistors, a second upper thermal range compensation stage including one of the second thermistors and one or more linearizing resistors, at least one zero-offset adjustment stage, at least one zero-offset thermal compensation stage, and at least one span adjustment stage.

In some examples, wherein the pressure sensing element has a maximum error of +/−1.5 percent of full scale. In some examples, the lower thermal range includes 0 degrees Celsius to −55 degrees Celsius, and wherein the upper thermal range includes 85 degrees Celsius to 150 degrees Celsius.

Another embodiment is directed to a method for making a pressure sensor utilizing a four-thermistor circuit. The method includes coupling a first thermistor for compensation in a lower thermal range and a second thermistor for compensation in an upper thermal range in series to a first input of an unamplified micro-electromechanical system (MEMS) pressure sensing die. The method also includes coupling a third thermistor for compensation in the lower thermal range and a fourth thermistor for compensation in the upper thermal range in series to a second input of an unamplified MEMS pressure sensing element. The method also includes coupling one or more outputs of the MEMS pressure sensing element to a connector configured to interface with an external device.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a diagram of an example pressure sensor utilizing a four-thermistor circuit to improve the accuracy of an unamplified MEMS pressure sensor in accordance with some embodiments of the present disclosure.

FIG. 2 sets forth a diagram of an example circuit for utilizing a four-thermistor circuit to improve the accuracy of an unamplified MEMS pressure sensor in accordance with some embodiments of the present disclosure.

FIG. 3 sets forth a diagram of an example circuit for utilizing a four-thermistor circuit to improve the accuracy of an unamplified MEMS pressure sensor in accordance with some embodiments of the present disclosure.

FIG. 4 sets forth a diagram of an example circuit for utilizing a four-thermistor circuit to improve the accuracy of an unamplified MEMS pressure sensor in accordance with some embodiments of the present disclosure.

FIG. 5 sets forth a flowchart of an example method for utilizing a four-thermistor circuit to improve the accuracy of an unamplified MEMS pressure sensor in accordance with some embodiments of the present disclosure.

### DETAILED DESCRIPTION

The advantages, and other features of the systems and methods disclosed herein, will become more readily apparent to those having ordinary skill in the art from the following detailed description of certain embodiments taken in conjunction with the drawings which set forth representative embodiments of the present invention.

In the description, common features are designated by common reference numbers throughout the drawings. As used herein, various terminology is used for the purpose of describing particular implementations only and is not intended to be limiting. For example, the singular forms “a,” “an,” and “the” are intended to include the plural forms as well, unless the context clearly indicates otherwise. It may be further understood that the terms “comprise,” “comprises,” and “comprising” may be used interchangeably with “include,” “includes,” or “including.” Additionally, it will be understood that the term “wherein” may be used interchangeably with “where.” As used herein, “exemplary” may indicate an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc. As used herein, “directly coupled” may include two devices that are coupled (e.g., communicatively coupled, electrically coupled, or physically coupled) without intervening components.

Further, words defining orientation such as “upper”, “lower”, “inner”, and “outer” are merely used to help describe the location of components with respect to one another. For example, an “inner” surface of a part is merely meant to describe a surface that is separate from the “outer” surface of that same part. No words denoting orientation are used to describe an absolute orientation (i.e., where an “inner” part must always be inside a part).

Note that techniques herein are well suited for use in any type of sensor application such as pressure sensor assemblies as discussed herein. However, it should be noted that embodiments herein are not limited to use in such applications and that the techniques discussed herein are well suited for other applications as well.

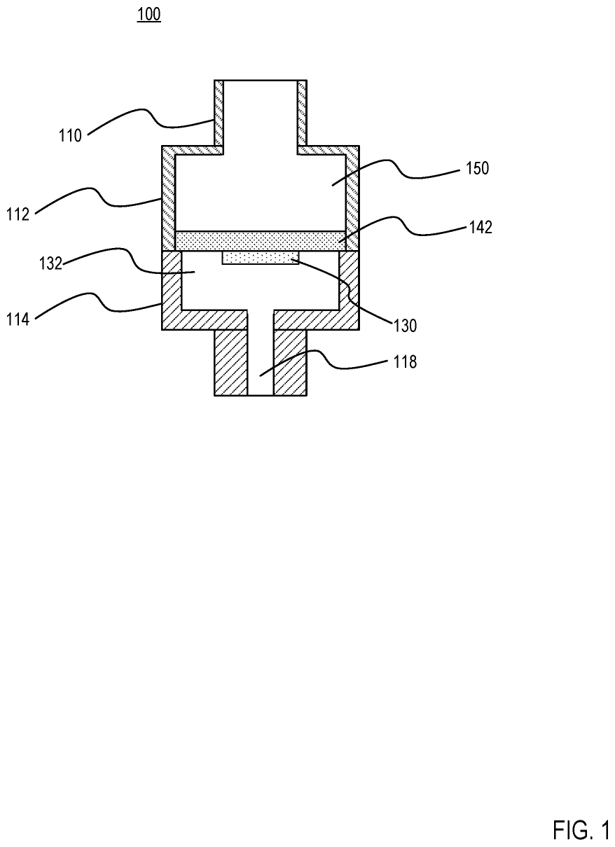

FIG. 1 sets forth a diagram of an example pressure sensor 100 utilizing a four-thermistor circuit to improve the accuracy of an unamplified MEMS pressure sensor in accordance with some embodiments of the present disclosure. The pressure sensor is configured for use within various applications, such as aerospace applications. The example pressure sensor of FIG. 1 includes a connector 110, a housing 112, and a solid steel port body 114 that are coupled together and enclose the other components of the pressure sensor 100. An opening in the port body 114 allows fluid to flow from a fluid medium into an interior channel 118 defined by peripheral walls of the port body 114. In some examples, threads on the exterior of the port body 114 allow fixation of the port body 114 to a structure (not shown) surrounding the fluid medium, keeping the interior channel 118 fluidly connected to the fluid medium. For example, the port body 114 may be threaded to screw into a structure surrounding the fluid medium. In other examples, the port body 114 may include a threaded cavity to receive a threaded member, or may be affixed by brazing, or through other techniques that will occur to those of skill in the art.

The pressure sensor includes a pressure sensing element 130. In some examples, the pressure sensing element 130 is disposed within an interior cavity 132 defined by peripheral walls of the port body 114 that is fluidly connected with the interior channel 118. In some examples, the pressure sensing element 130 is a micro-electromechanical system (MEMS) die that includes a diaphragm in contact with one or more piezoresistive strain gauges. A change in the pressure of the fluid medium imparts a force onto the diaphragm that is measured by the strain gauges, which in turn generate an electrical signal that represents the change in pressure, as is well known in the art.

The pressure sensing element is electrically coupled to a printed circuit board (PCB) 142 or other electronics module assembly (EMA). In some examples, a seal between the port body 114 and the PCB 142 prevents the fluid medium from escaping the interior cavity 132 in which the pressure sensing element 130 is disposed. In some examples, the pressure sensing element 130 is directly mounted to the PCB 142. Alternatively, the pressure sensing element 130 may be electrically coupled to the PCB 142 through wiring or ribbon. In some examples, the PCB 142 is disposed within an interior cavity 150 defined by peripheral walls of the housing 112. The housing 112 may also enclose wiring, springs, or other electrical couplers that connect the PCB 142 to a monitoring device via the connector 110. Circuitry on the PCB 142 receives electrical signals from the strain gauges of the pressure sensing element 130 and provides calibrated electrical outputs through one or more output ports of the connector 110.

In a piezoresistive micro-electromechanical system (MEMS) pressure sensor, the sensitivity of the sensor decreases as temperature increases. For an unamplified pressure sensor, passive elements such as thermistors are utilized to provide thermal compensation to calibrate the pressure sensor. In particular, negative temperature coefficient (NTC) thermistors are used for thermal compensation. NTC thermistors are resistors with a negative temperature coefficient, which means that the resistance decreases with increasing temperature. Thermistors have high sensitivity, in that a small change in temperature causes a large change in resistance. Also, the response of the thermistor is not linear over the full operational temperature range of the thermistor. That is, the change in resistance for a given change in temperature is not constant over the thermistor's temperature range. The thermistor response can be linearized by placing a fixed resistor in parallel and/or in series with it.

To better understand the role of the NTC thermistor in thermal compensation, it will be recognized that NTC thermistors are characterized by a number of manufacturer-specified operational parameters. One such parameter is resistance, which is the thermistor resistance at the temperature specified by the manufacturer, often 25° C. Another parameter is tolerance, which indicates how much the resistance can vary from the specified value, typically expressed in percent. For example, if the specified resistance at 25° C. for a thermistor with 10% tolerance is 10,000 ohms then the measured resistance at that temperature can range from 9,000 ohms to 11000 ohms. Another parameter is the Beta coefficient (also referred to as the Beta constant, Beta sensitivity parameter, or simply Beta). The Beta coefficient is a value that represents the relationship between the resistance and temperature over a specified temperature range. For example, “3380 25/50” indicates a beta constant of 3380 over a temperature range from 25° C. to 50° C. Often, the Beta coefficient is specified simply as, for example, 3380 in degrees Kelvin. Another parameter is the operating temperature range, including the minimum and maximum thermistor operating temperature. Yet another parameter is the thermal time constant, which represents the time it takes to reach 63% of the difference between the old and new temperatures. Yet another parameter is the thermal dissipation constant, which is the amount of power required to raise the thermistor temperature by 1° C. as a result of self-heating. Normally, power dissipation should be kept low to prevent self-heating. Another parameter is the maximum power dissipation to prevent damage to the thermistor. Additional characteristics include a resistance temperature table, which is a table of resistance values and associated temperatures over the thermistors operating temperature range, as specified by the thermistor manufacturer.

An NTC thermistor can be provided on the input voltage to the MEMS sense element to provide thermal compensation when the pressure sensor is operating in the “hot” temperature range. As used herein, the “hot” temperature range may be approximately room temperature and above (e.g., approximately 25° C. to approximately 150° C.). An NTC thermistor has been shown to effectively reduce error in the pressure sensor within the hot temperature range. However, pressure sensors may also experience significant error in a “cold” temperature range. As used herein, the “cold temperature range may be approximately freezing temperature and below (e.g., approximately 0° C. to approximately −55° C.). Percentage error at full scale may reach 4% at −55° C. The thermistor used for hot thermal compensation does not typically provide sufficient thermal compensation in the cold temperature range.

In accordance with embodiments of the present disclosure, a pressure sensor is provided with multiple thermistors that have differing characteristics to provide both hot and cold thermal compensation. In some examples, the pressure sensor 100 includes one or more lower thermal range, or ‘cold,’ compensation thermistors that calibrate the output signal of the pressure sensing element 130 to compensate for thermal deviation in cold temperature conditions (e.g., below approximately 0° C.), and one or more upper thermal range, or ‘hot,’ compensation thermistors that calibrate the output signal of the pressure sensing element 130 to compensate for thermal deviation in hot temperature conditions (e.g., above approximately 85° C.). In some examples, the PCB 142 includes two or more cold temperature compensation thermistors and two or more hot temperature compensation thermistors.

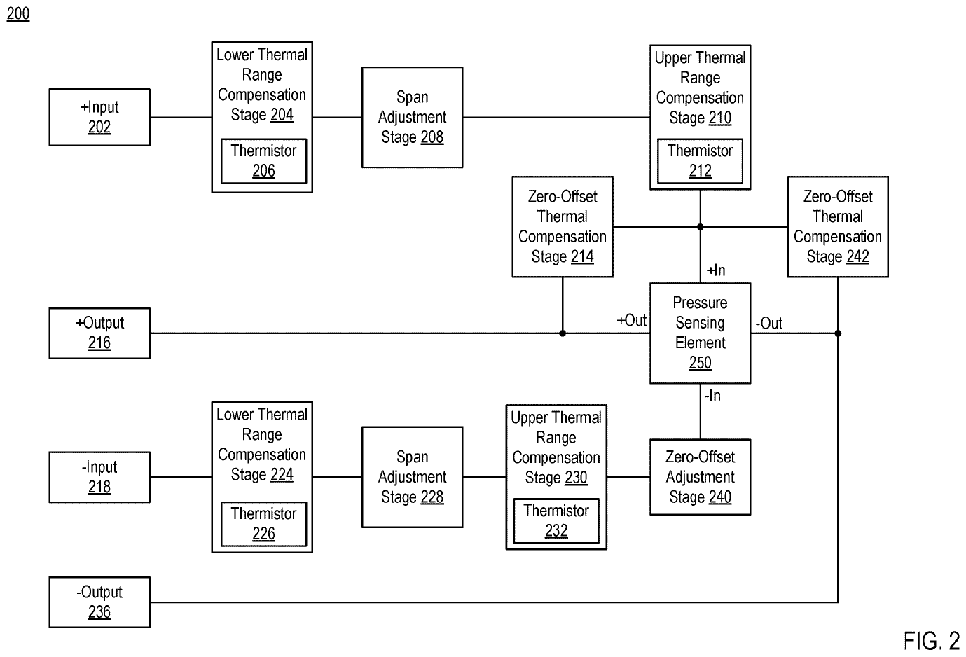

For further explanation, FIG. 2 sets forth a block diagram of an example pressure sensor 200 utilizing a four-thermistor circuit to improve accuracy in accordance with some embodiments of the present disclosure. The example of FIG. 2 provides passive elements for compensation and adjustment to a MEMS pressure sensing element 250. The example of FIG. 2 includes a positive voltage input 202 that is fed into a lower thermal range compensation stage 204, or ‘cold’ compensation stage that compensates for deviation in the MEMS pressure sensing element 250 in cold temperatures. The lower thermal range compensation stage 204 includes one or more resistors and at least one lower thermal range compensation thermistor 206. The one or more resistors in the lower thermal range compensations stage 204 may also include resistors for linearizing the output of the lower thermal range compensation thermistor 206, and may include one or more trimmable resistors. In some examples, the lower thermal range compensation thermistor 206 is an NTC thermistor having an impedance of 10 Ω and a beta coefficient of 3470 K. NTC thermistors with such values are commonly available. However, it will be appreciated that other values for the lower thermal range compensation thermistor 206 can be selected based on operational characteristics and operating conditions of the pressure sensor. For example, input voltage, MEMS sense element characteristics, target pressure range, and target temperature range may inform the selection of values for the thermistor 206.

The output of the lower thermal range compensation stage 204 is fed to a span compensation stage 208. The span adjustment stage 208 includes one or more resistors for adjusting the span of the full scale output of the MEMS pressure sensing element 250. In some examples, the span adjustment stage 208 includes a trimmable resistor.

The output of the span compensation stage 208 is fed into an upper thermal range compensation stage 210, or ‘hot’ compensation stage that compensates for deviation in the MEMS pressure sensing element 250 when the ambient conditions are within an upper thermal range (e.g., 85° C. to 150° C.) relative to the lower thermal range. The upper thermal range compensation stage 210 includes one or more resistors and at least one upper thermal range compensation thermistor 212. The upper thermal range compensation stage 210 may also include other resistors for linearizing the output of the upper thermal range compensation thermistor 212, which may include one or more trimmable resistors. In some examples, the upper thermal range compensation thermistor 212 is an NTC thermistor having an impedance of 500 Ω and a beta coefficient of 2941 K. NTC thermistors with such values are commonly available. However, it will be appreciated that other values for the upper thermal range compensation thermistor 212 can be selected based on operational characteristics and operating conditions of the pressure sensor. For example, input voltage, MEMS sense element characteristics, target pressure range, and target temperature range may inform the selection of values for the upper thermal range compensation thermistor 212, as will be understood by those of skill in the art.

The output of the upper thermal range compensation stage 210 is fed to a first zero-offset thermal compensation stage 214 in parallel with the MEMS pressure sensing element 250 and a second zero-offset thermal compensation stage 242. The zero-offset thermal compensation stages 214, 242 each includes one or more resistors that compensate for the thermal sensitivity of the offset voltage of the MEMS pressure sensing die 250. The zero-offset thermal compensation stages 214, 242 may include a trimmable resistor.

A positive output terminal 216 is connected in parallel to the output of the zero-offset thermal compensation stage 214 and the positive output of the MEMS pressure sensing element 250. A negative output terminal 236 is connected in parallel to the output of the zero-offset thermal compensation stage 242 and the negative output of the MEMS pressure sensing element 250

The example of FIG. 2 also includes a negative input 218 that is fed into a lower thermal range compensation stage 224, or ‘cold’ compensation stage that compensates for deviation in the MEMS pressure sensing element 250 in cold temperatures (e.g., below 0 ° C.). The lower thermal range compensation stage 224 includes one or more resistors and at least one lower thermal range compensation thermistor 226. The lower thermal range compensations stage 224 may also include resistors for linearizing the output of the lower thermal range compensation thermistor 226, and may include one or more trimmable resistors. In some examples, the lower thermal range compensation thermistor 226 is an NTC thermistor having an impedance of 10 Ω and a beta coefficient of 3470 K. NTC thermistors with such values are commonly available. However, it will be appreciated that other values for the lower thermal range compensation thermistor 226 can be selected based on operational characteristics and operating conditions of the pressure sensor. For example, input voltage, MEMS sense element characteristics, target pressure range, and target temperature range may inform the selection of values for the thermistor 226, as will be understood by those of skill in the art.

The output of the lower thermal range compensation stage 224 is fed to a span adjustment stage 228. The span adjustment stage 228 includes one or more resistors for adjusting the span of the full scale output of the MEMS pressure sensing element 250. In some examples, the span adjustment stage 228 includes a trimmable resistor.

The output of the span compensation stage 228 is fed into an upper thermal range compensation stage 230, or ‘hot’ compensation stage that compensates for deviation in the MEMS pressure sensing element 250 within the upper thermal range. The upper thermal range compensation stage 230 includes one or more resistors and at least one upper thermal range compensation thermistor 232. The upper thermal range compensation stage 230 may also include other resistors for linearizing the output of the upper thermal range compensation thermistor 232, which may include one or more trimmable resistors. In some examples, the upper thermal range compensation thermistor 232 is an NTC thermistor having an impedance of 500 Ω and a beta coefficient of 2941 K. NTC thermistors with such values are commonly available. However, it will be appreciated that other values for the upper thermal range compensation thermistor 232 can be selected based on operational characteristics and operating conditions of the pressure sensor. For example, input voltage, MEMS sense element characteristics, target pressure range, and target temperature range may inform the selection of values for the upper thermal range compensation thermistor 232, as will be understood by those of skill in the art.

The output of the upper thermal range compensation stage 230 is fed to a zero-offset adjustment stage 240. The MEMS pressuring sensing element 250 outputs an offset voltage when no pressure is applied. One or more resistors, which may include trimmable resistors, in the zero-offset adjustment stage 240 calibrates the offset voltage. The output of the zero-offset adjustment stage 240 is supplied as the negative input(s) to the MEMS pressure sensing element 250.

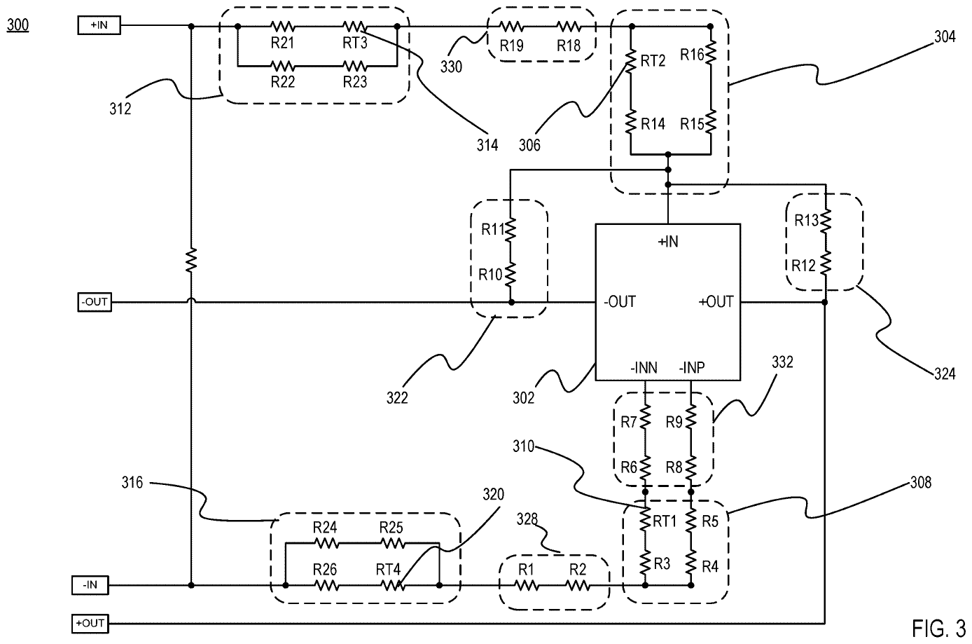

For further explanation, FIG. 3 sets forth a diagram of an example circuit 300 for utilizing a four-thermistor circuit to improve the accuracy of an unamplified MEMS pressure sensor in accordance with some embodiments of the present disclosure. The example circuit 300 includes a pressure sensor element 302 that is a MEMS pressure sensing die. A first voltage input (e.g., in this example a positive input) to the pressure sensor element 302 is calibrated by a first cold compensation thermistor network 312 for cold temperature calibration. The first cold compensation thermistor network 312 includes a network of resistors including a first cold compensation thermistor 314 (labeled ‘RT3’) as well as other resistors R21, R22, R23 for linearization. In one example, the first cold compensation thermistor 314 is an NTC thermistor with a resistance of 10 Ω at room temperature. In such an example, the thermistor 314 may have a Beta coefficient of 3470. The values of the other resistors R21, R22, R23 may be selected in accordance with desired circuit characteristics for a particular application, as will be recognized by those of ordinary skill in the art. The first voltage input is further calibrated by a first hot compensation thermistor network 304 for room and/or hot temperature calibration. The first hot compensation thermistor network 304 includes a network of resistors including a first hot compensation thermistor 306 (labeled ‘RT2’) as well as other resistors R14, R15, R16 for linearization. In one example, the first hot compensation thermistor 306 is an NTC thermistor with a resistance of 500 Ω at room temperature. In such an example, the thermistor 306 may have a Beta coefficient of 2941. The values of the other resistors R14, R15, R16 may be selected in accordance with desired circuit characteristics for a particular application, as will be recognized by those of ordinary skill in the art. The example circuit 300 also includes a span adjustment network 330, including one or more resistors (labeled R18, R19), that couples the first cold compensation thermistor network 312 and the first hot compensation thermistor network 304. The example circuit 300 further includes one or more zero-offset adjustment resistor networks 322, 324 including one or more resistors (e.g., labeled R10, R11, R12, R13) for zero-offset adjustment.

One or more second voltage inputs (e.g., in this example a negative input) to the pressure sensor element 302 is calibrated by a second cold compensation thermistor network 316 for cold temperature calibration. The second cold compensation thermistor network 316 includes a network of resistors including a second cold compensation thermistor 320 (labeled ‘RT3’) as well as other resistors R21, R22, R23 for linearization. In one example, the second cold compensation thermistor 320 is an NTC thermistor with a resistance of 10 Ω at room temperature. In such an example, the thermistor 320 may have a Beta coefficient of 3470. The values of the other resistors R21, R22, R23 may be selected in accordance with desired circuit characteristics for a particular application, as will be recognized by those of ordinary skill in the art. The first voltage input is further calibrated by a second hot compensation thermistor network 308 for hot temperature calibration. The second hot compensation thermistor network 308 includes a network of resistors including a second hot compensation thermistor 310 (labeled ‘RT1’) as well as other resistors R3, R4, R5 for linearization. In one example, the second hot compensation thermistor 310 is an NTC thermistor with a resistance of 500 Ω at room temperature. In such an example, the thermistor 310 may have a Beta coefficient of 3941. The values of the other resistors R3, R4, R5 may be selected in accordance with desired circuit characteristics for a particular application, as will be recognized by those of ordinary skill in the art. The example circuit 300 also includes a span adjustment network 328, including one or more resistors (labeled R1, R2), that couples the second cold compensation thermistor network 316 and the second hot compensation thermistor network 308. The example circuit 300 further includes one or more zero-offset resistor networks 332 including one or more resistors (e.g., labeled R6, R7, R8, R9) for zero-offset thermal compensation or adjustment.

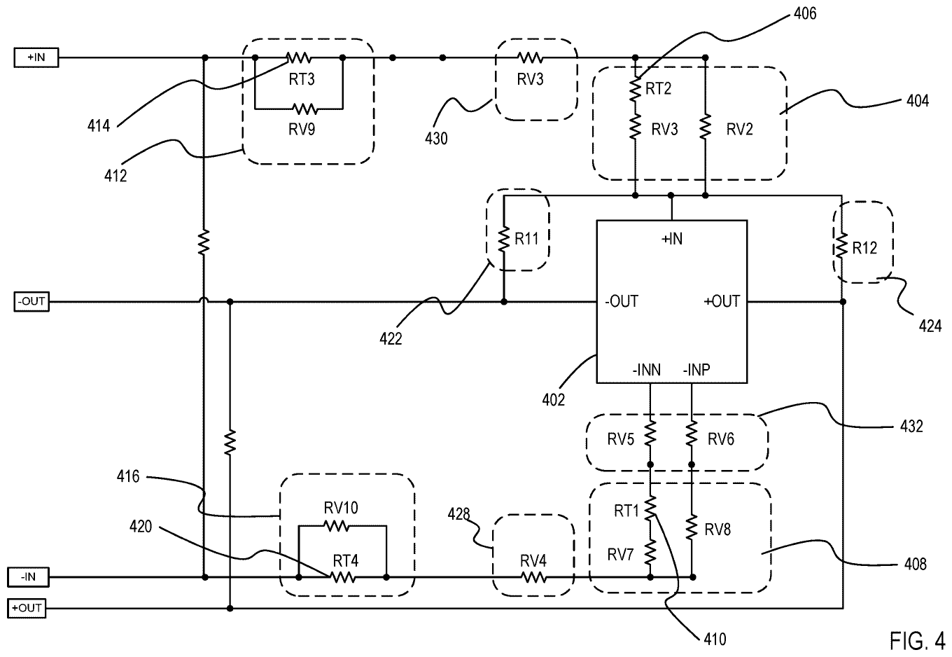

For further explanation, FIG. 4 sets forth a diagram of an example circuit 400 for utilizing a four-thermistor circuit to improve the accuracy of an unamplified MEMS pressure sensor in accordance with some embodiments of the present disclosure. The example circuit 400 includes a pressure sensor element 402 that is a MEMS pressure sensing die. A first voltage input (e.g., in this example a positive input) to the pressure sensor element 402 is calibrated by a first cold compensation thermistor network 412 for cold temperature calibration. The first cold compensation thermistor network 412 includes a network of resistors including a first cold compensation thermistor 414 (labeled ‘RT3’) as well as one or more trimmable resistors RV9 for linearization. In one example, the first cold compensation thermistor 414 is an NTC thermistor with a resistance of 10 Ω at room temperature. In such an example, the thermistor 414 may have a Beta coefficient of 3470. The first voltage input is further calibrated by a first hot compensation thermistor network 404 for room and/or hot temperature calibration. The first hot compensation thermistor network 404 includes a network of resistors including a first hot compensation thermistor 406 (labeled ‘RT2’) as well as one or more trimmable resistors RV1, RV2 for linearization. In one example, the first hot compensation thermistor 406 is an NTC thermistor with a resistance of 500 Ω at room temperature. In such an example, the thermistor 406 may have a Beta coefficient of 2941. The example circuit 400 also includes a span adjustment network 430 including one or more trimmable resistors RV3 coupling the first cold compensation thermistor network 412 and the first hot compensation thermistor network 404. The example circuit 400 further includes one or more zero-offset thermal compensation resistor networks 422, 424 including one or more resistors (e.g., labeled R11, R12) for zero-offset thermal compensation.

One or more second voltage inputs (e.g., in this example a negative input) to the pressure sensor element 402 is calibrated by a second cold compensation thermistor network 416 for cold temperature calibration. The second cold compensation thermistor network 416 includes a network of resistors including a second cold compensation thermistor 420 (labeled ‘RT3’) as well as other one or more trimmable resistors RV9 for linearization. In one example, the second cold compensation thermistor 420 is an NTC thermistor with a resistance of 10 Ω at room temperature. In such an example, the thermistor 420 may have a Beta Sensitivity Coefficient of 3470. The first voltage input is further calibrated by a second hot compensation thermistor network 408 for room and/or hot temperature calibration. The second hot compensation thermistor network 408 includes a network of resistors including a second hot compensation thermistor 410 (labeled ‘RT1’) as well as one or more trimmable resistors RV7, RV8 for linearization. In one example, the second hot compensation thermistor 410 is an NTC thermistor with a resistance of 500 Ω at room temperature. In such an example, the thermistor 410 may have a Beta coefficient of 2941. The example circuit 400 also includes a span adjustment network 428 including one or more trimmable resistors RV4 coupling the second cold compensation thermistor network 416 and the second hot compensation thermistor network 408. The example circuit 400 further includes one or more zero-offset adjustment networks 432 including one or more resistors RV5, RV6 for zero-offset adjustment.

An improved electrical circuit design in accordance with the present disclosure, in which four thermistors are used, demonstrates an enhancement in overall accuracy, especially at cold temperatures. Test results on low/high pressure sensors ranging from 25 PSI up to 5000 PSI show that accuracy is enhanced by reducing error to with ±1.5% full scale across a wide temperature range, e.g., from −55° C. to +150° C.

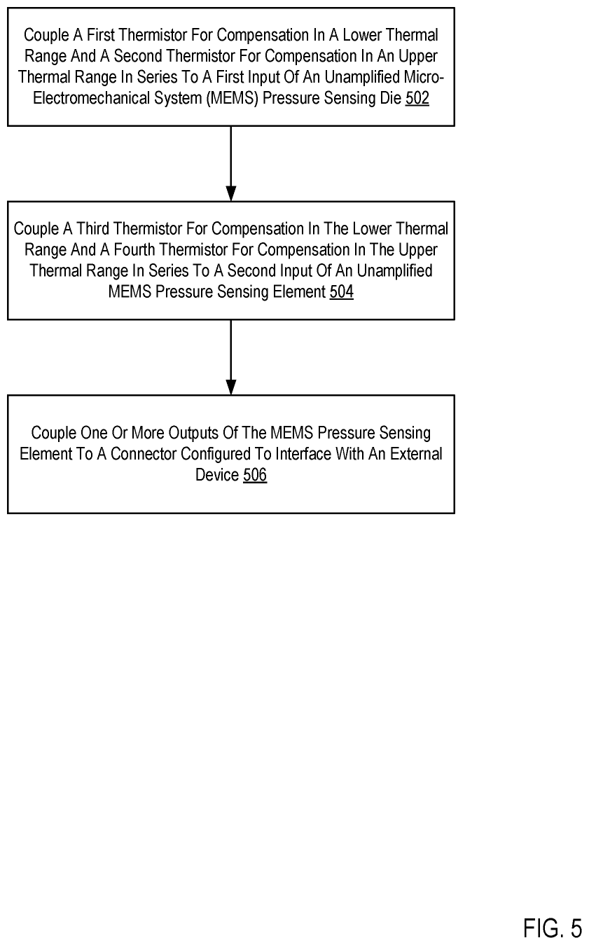

For further explanation, FIG. 5 sets forth a flowchart of an example method of utilizing a four-thermistor circuit to improve the accuracy of an unamplified MEMS pressure sensor in accordance with some embodiments of the present disclosure. The method of FIG. 5 includes coupling 502 a first thermistor for compensation in a lower thermal range and a second thermistor for compensation in an upper thermal range in series to a first input of an unamplified MEMS pressure sensing element. In some examples, coupling 502 the first thermistor and the second thermistor in series to a first input of the MEMS pressuring sensing element may be carried out by attaching the MEMS pressure sensing die to a printed circuit board (PCB), attaching the first thermistor to the PCB, attaching the second thermistor to the PCB, and providing a signal pathway connecting the first thermistor and the second thermistor in series to a positive input of the MEMS pressure sensing element. In a particular example, coupling 502 the first thermistor and the second thermistor in series to a first input of the MEMS pressuring sensing element may be carried out by, for example, implementing one of the above-described circuits on a PCB.

The method of FIG. 5 also includes coupling 504 a third thermistor for compensation in the lower thermal range and a fourth thermistor for compensation in the upper thermal range in series to a second input of an unamplified MEMS pressure sensing element. In some examples, coupling 504 the third thermistor and the fourth thermistor in series to a second input of the MEMS pressuring sensing element may be carried out by attaching the third thermistor to the PCB, attaching the fourth thermistor to the PCB, and providing a signal pathway connecting the third thermistor and the fourth thermistor in series to a negative input of the MEMS pressure sensing element. In a particular example, coupling 504 the third thermistor and the fourth thermistor in series to a second input of the MEMS pressuring sensing element may be carried out by, for example, implementing one of the above-described circuits on a PCB.

The method of FIG. 5 also includes coupling 506 one or more outputs of the MEMS pressure sensing element to a connector configured to interface with an external device. In some examples, coupling 506 one or more outputs of the MEMS pressure sensing element to a connector is carried out by connecting a positive output of the MEMS pressure sensing element to a positive output terminal and connecting a negative output of the MEMS pressure sensing element to a negative output terminal on the PCB, and electrically connecting the positive output terminal and the negative output terminal to a connector for coupling with an external device that measures a differential across the positive and negative output.

In view of the foregoing, it will be appreciated that a pressure sensor including two or more thermistors for lower thermal range compensation and two or more thermistors for upper thermal range compensation reduces error, increases the reliability of the pressure sensor measurements, and extends the temperature conditions in which the pressure sensor can be reliably operated.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A pressure sensor utilizing a four-thermistor circuit to improve accuracy, the pressuring sensor comprising:
a pressure sensing element;
two or more first thermistors electrically coupled to the pressure sensing element, the two or more first thermistors providing compensation for deviation of the pressure sensing element in a lower thermal range; and
two or more second thermistors electrically coupled to the pressure sensing element, the two or more second thermistors providing compensation for deviation of the pressure sensing element in an upper thermal range.

2. The pressure sensor of claim 1, wherein the pressure sensing element has a maximum error of +/−1.5 percent of full scale. cm 3. The pressure sensor of claim 1, wherein the lower thermal range includes 0 degrees Celsius to −55 degrees Celsius, and wherein the upper thermal range includes 85 degrees Celsius to 150 degrees Celsius.

4. The pressure sensor of claim 1, wherein the two or more first thermistors have a resistance of 10 Ω at room temperature.

5. The pressure sensor of claim 1, wherein the two or more first thermistors have a beta sensitivity coefficient of 3470.

6. The pressure sensor of claim 1, wherein the two or more second thermistors have a resistance of 500 Ω at room temperature.

7. The pressure sensor of claim 1, wherein the two or more second thermistors have a beta sensitivity coefficient of 2941.

8. The pressure sensor of claim 1, wherein the pressure sensing element is a micro-electromechanical system (MEMS) die.

9. The pressure sensor of claim 8, wherein the MEMS die is mounted on a printed circuit board (PCB) assembly; and wherein the two or more first thermistors and the two or more second thermistors are disposed on the PCB assembly.

10. The pressure sensor of claim 9, wherein the PCB assembly includes:
a first lower thermal range compensation stage including one of the first thermistors and one or more linearizing resistors;
a second lower thermal range compensation stage including one of the first thermistors and one or more linearizing resistors;
a first upper thermal range compensation stage including one of the second thermistors and one or more linearizing resistors;
a second upper thermal range compensation stage including one of the second thermistors and one or more linearizing resistors;
at least one zero-offset adjustment stage;
at least one zero-offset thermal compensation stage; and
at least one span adjustment stage.

11. The pressure sensor of claim 1, wherein the pressure sensor is an unamplified pressure sensor.

12. The pressure sensor of claim 1, wherein the pressure sensor is piezoresistive pressure sensor.

13. A method of a pressure sensor utilizing a four-thermistor circuit, the method comprising:
coupling a first thermistor for compensation in a lower thermal range and a second thermistor for compensation in an upper thermal range in series to a first input of an unamplified micro-electromechanical system (MEMS) pressure sensing die;
coupling a third thermistor for compensation in the lower thermal range and a fourth thermistor for compensation in the upper thermal range in series to a second input of an unamplified MEMS pressure sensing element; and
coupling one or more outputs of the MEMS pressure sensing element to a connector configured to interface with an external device.

14. The method of claim 13, wherein the MEMS pressure sensing element has a maximum error of +/−1.5 percent of full scale.

15. The method of claim 13, wherein the lower thermal range includes 0 degrees Celsius to −55 degrees Celsius, and wherein the upper thermal range includes 85 degrees Celsius to 150 degrees Celsius.

16. The method of claim 13, wherein the two or more first thermistors have a resistance of 10 Ω at room temperature.

17. The method of claim 13, wherein the two or more first thermistors have a beta sensitivity coefficient of 3470.

18. The method of claim 13, wherein the two or more second thermistors have a resistance of 500 Ω at room temperature.

19. The method of claim 13, wherein the two or more second thermistors have a beta sensitivity coefficient of 2941.

20. The method of claim 13, wherein the pressure sensor is piezoresistive pressure sensor.
